(19) United States
(12) Patent Application Publication
(10) Pub. No.: US 2006/0249542 A1
(43) Pub. Date: Nov. 9, 2006

(54) Dispensing device for materials, method and system of use thereof

(76) Inventor: Randall E. Allen, Troy, NY (US)

Correspondence Address: SCHMEISER, OLSEN & WATTS, 22 CENTURY HILL DRIVE, SUITE 302, LATHAM, NY, 12110, US

(21) Appl. No.: 11/114,618

(22) Filed: Apr. 26, 2005

(51) Int. Cl. B65D 88/54; G01F 11/00

(52) U.S. Cl. 222/333

(57) ABSTRACT

The invention relates generally to a device for dispensing materials, especially reactive and abrasive fluids; and a system and method of use thereof. Disclosed is a device for dispensing material from a syringe which includes a plunger retainer, a drive mechanism, a receiver for a syringe, a multi-directional flow valve, and a sensor. Also disclosed is a method for dispensing material which includes providing a device for dispensing the material, providing a syringe, providing a reservoir for containing the material, operatively coupling the dispensing device to a multi-degree of freedom robotic apparatus; and dispensing the material onto a workpiece. Also disclosed is a system for dispensing materials which includes a device for dispensing materials, a reservoir for containing the material, a syringe wherein the syringe is co-operable with the device, a multi-degree of freedom robotic apparatus operatively coupled to the device; and a drive system for supplying motive power.

### BACKGROUND OF THE INVENTION

1. Field of the invention

The present invention relates to a device, a method, and a system for dispensing materials, and in particular, reactive and abrasive fluids.

2. Related art

In the field of material dispensing, efforts toward devices and systems able to effectively dispense materials are continuously being made, especially, costly materials such as reactive and abrasive fluids. Due to the complexity and material composition of present day devices, their utilization for such materials is limited and impractical due the required frequent disassembly for cleaning, maintenance, and/or rebuilding with new parts.

Further, the costs of maintenance and cleaning of the devices and the systems is highly regarded. With most material dispensing devices and systems, significant man-hours and manufacturing downtime, which translate into costs, must be expended to clean the devices and the systems between dispensing cycles, uses, work shifts, or material changes.

Thus, there is a need for a device, system and method which overcomes the aforementioned, and other, deficiencies in the art of dispensing materials.

### SUMMARY OF THE INVENTION

In a first general aspect of the present invention is provided a device for dispensing material from a syringe, said syringe having a plunger with a terminal plate and a piston; and a syringe barrel for receiving the piston comprising: a plunger retainer, for releasably attaching the terminal plate of said plunger; a drive mechanism, adapted to provide motive force to said plunger head retainer; a receiver for said syringe; a multi-directional flow valve capable of fluid communication with a reservoir; and a sensor for determining an amount of material dispensed from said syringe.

In a second general aspect of the present invention is provided a method for dispensing material from a syringe, said syringe having a plunger with a terminal plate and a piston; and a syringe barrel for receiving the piston comprising: providing a device for dispensing material, wherein said dispensing device is co-operable with a syringe; providing said syringe, said syringe being co-operable with said dispensing device; providing a reservoir for containing said material, wherein said reservoir is in fluid communication with said dispensing device; operatively coupling said dispensing device to a multi-degree of freedom robotic apparatus; and dispensing said material onto a workpiece.

In a third general aspect of the present invention is provided a system for dispensing material from a syringe, said syringe having a plunger with a terminal plate and a piston; and a syringe barrel for receiving the piston comprising: a device for dispensing material, wherein said dispensing device is co-operable with a syringe; a reservoir for containing said material wherein said reservoir is in fluid communication with said dispensing device; a syringe wherein said syringe is co-operable with said device; a multi-degree of freedom robotic apparatus operationally coupled to said device; and a drive system, for supplying motive power to move said robotic apparatus in multi-degrees of freedom, said drive system operationally coupled to said robotic apparatus.

In a fourth general aspect of the present invention is provided a device dispensing material comprising: a syringe for dispensing material, said syringe having a plunger with a terminal plate and a piston; and a syringe barrel for receiving said piston; a sensor for determining an amount of said material dispensed from said syringe; a multi-directional flow valve, wherein the flow valve is in fluid communication with a reservoir, wherein said reservoir is for containing said material; and a receiver for securing various size syringes.

In a fifth general aspect of the present invention is provided a system for dispensing material comprising: a device, wherein the device is operably coupled to a syringe, said syringe having a plunger and a piston; and a syringe barrel for receiving said piston and further wherein said dispensing device has a multi-directional flow valve; a reservoir for containing a material wherein said reservoir is in fluid communication with said dispensing device; a multi-degree of freedom robotic apparatus operationally coupled to said dispensing device; and a drive system, for supplying motive power to move said robotic apparatus in multi-degrees of freedom, said drive system operationally coupled to said robotic apparatus.

The foregoing and other features and advantages of the invention will be apparent from the following more particular description of preferred embodiments of the invention.

### BRIEF DESCRIPTION OF THE DRAWINGS

In order that those skilled in the art will be better able to practice the invention, reference will be made to the drawings, wherein:

FIG. 1 depicts a perspective view of a dispensing device in accordance with the present invention;

FIG. 2 depicts a perspective view of the dispensing device of FIG. 1 in co-operation with a syringe in accordance with the present invention;

FIG. 3 depicts a partially exploded view of a 3-way stopcock in accordance with the present invention;

FIG. 4 depicts a block diagram of a controller for use with the dispensing device and a dispensing system in accordance with the present invention;

FIG. 5 depicts a perspective view of a dispensing device in accordance with present invention;

FIG. 6 depicts a Cartesian coordinate system used in describing the motion of a method and a system for dispensing material in accordance with the present invention;

FIG. 7 depicts a top view of a dispensing system in accordance with the present invention;

FIG. 8 depicts a side view of the dispensing system in accordance with the present invention;

FIG. 9 depicts a front view of the dispensing system in accordance with the present invention;

FIG. 10 depicts a top view of a dispensing system in accordance with the present invention;

FIG. 11 depicts a side view of the dispensing system in accordance with the present invention; and

FIG. 12 depicts a front view of the dispensing system in accordance with the present invention.

### DETAILED DESCRIPTION OF PREFERRED EMBODIMENTS

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of the embodiment.

The present invention offers a device for dispensing materials, especially reactive and abrasive fluids. Reactive and abrasive fluids are two classes of materials often used in dispensing devices and systems. Reactive fluids are fluids having the properties: anaerobic, shear sensitive, light sensitive, moisture sensitive, pressure sensitive, and the like. Examples of reactive fluids include but are not limited to cyanoacrylate type fluids, moisture sensitve silicones, and UV sensitive urethanes. Abrasive fluids are fluids having solid or semi-solid materials suspended within a uniform, liquid medium. Abrasive fluids are often referred to as filled materials. Examples of abrasive fluids include but are not limited to filled silicones and room temperature vulcanizing (RTV) silicones, thermal transfer compounds, and silver filled coating.

Although for purposes of illustration only, an embodiment that can be used for dispensing inter alia reactive or abrasive fluids is disclosed herein. The apparatus and method can be readily used for dispensing other materials. For example, materials having a viscosity in a range from about 0 centipoise to about 10,000 centipoise or any material where dispensing of the material is required can utilize the present invention.

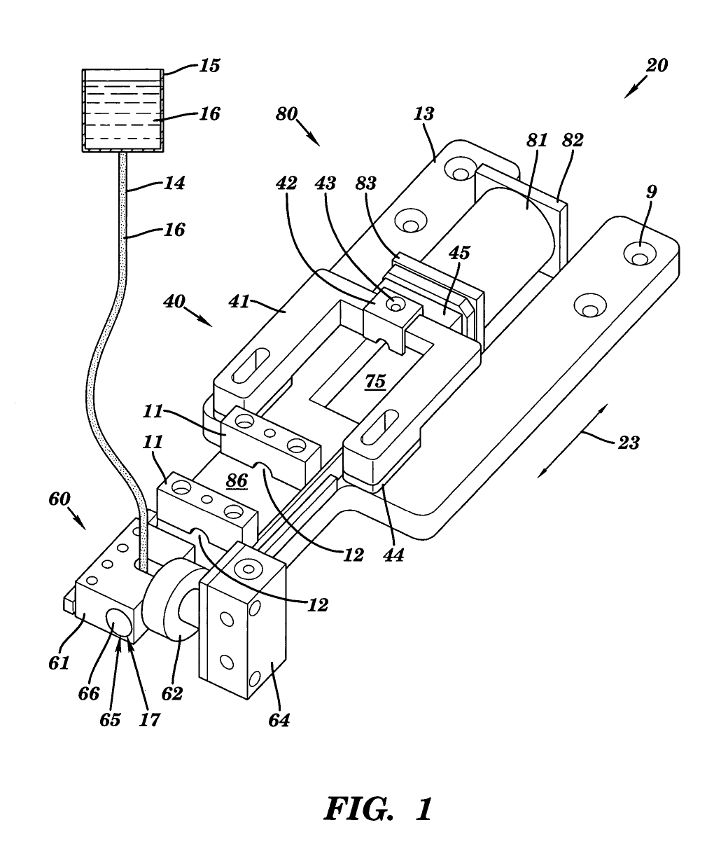

FIG. 1 depicts a device 20 for dispensing materials, especially reactive and abrasive fluids, in accordance with the present invention. An embodiment of the present invention is the dispensing device 20 comprising: a plunger retainer 40, a multi-directional flow valve 60, a receiver 75, a drive mechanism 80, and a sensor 95.

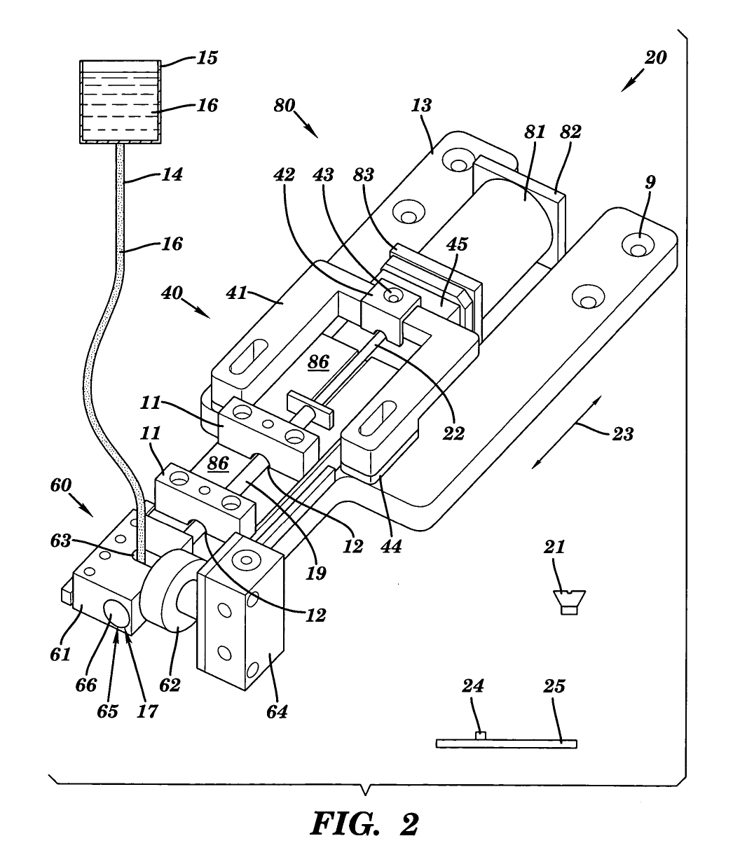

FIG. 2 depicts a device 20 for dispensing materials, especially reactive and abrasive fluids, with a syringe 19 operatively adapted to the device 20 in accordance with the present invention. Referring to FIG. 1 and FIG. 2, the receiver 75 is a space, region, area, or the like located on a first side, top, of a ball screw cover 86 of the device 20. The receiver 75 can accommodate any syringe 19 that is capable of being integrally or non-integrally adaptable to occupy the receiver 75. The volume range of the syringes 19 typically used in the device 20 ranges from about 0.5 μL to about 10 mL. Further, the syringes 19 typically used in the device 20 may be made of materials comprising: glass, silicate, boro-silicate, plastic, rubber, metal, Pyrex®, nanocomposites, and the like as well as combinations thereof.

The device 20 further comprises syringe brackets 11 having syringe accommodators 12 operatively adaptable to secure the syringe 19 to a first side, top, of a ball screw cover 86. The syringe brackets 11 are secured to the first side, top, of the cover 86 via at least one thumb screw 21. The accommodators 12 are operatively adaptable to secure syringes 19 having volumes in a range from about 0.5 μL to about 10 mL.

The plunger retainer 40 comprises: a syringe yolk 41, a syringe yolk fastener 42, a syringe yolk screw 43, and a syringe yolk carriage 44. The syringe yolk 41 is operatively coupled to the syringe carriage 44 and is operatively adapted to retain a terminal plate 26 of a syringe plunger 22. The terminal plate 26 may be flat or have any perpendicular extension capable of being held in the yolk 41. The syringe yolk screw 43 secures the plate 26 of the plunger 22 to the yolk 41 preventing the plunger 22 from becoming disengaged from the yolk 41. The yolk carriage 44 is operatively coupled to a ball screw shaft 85.

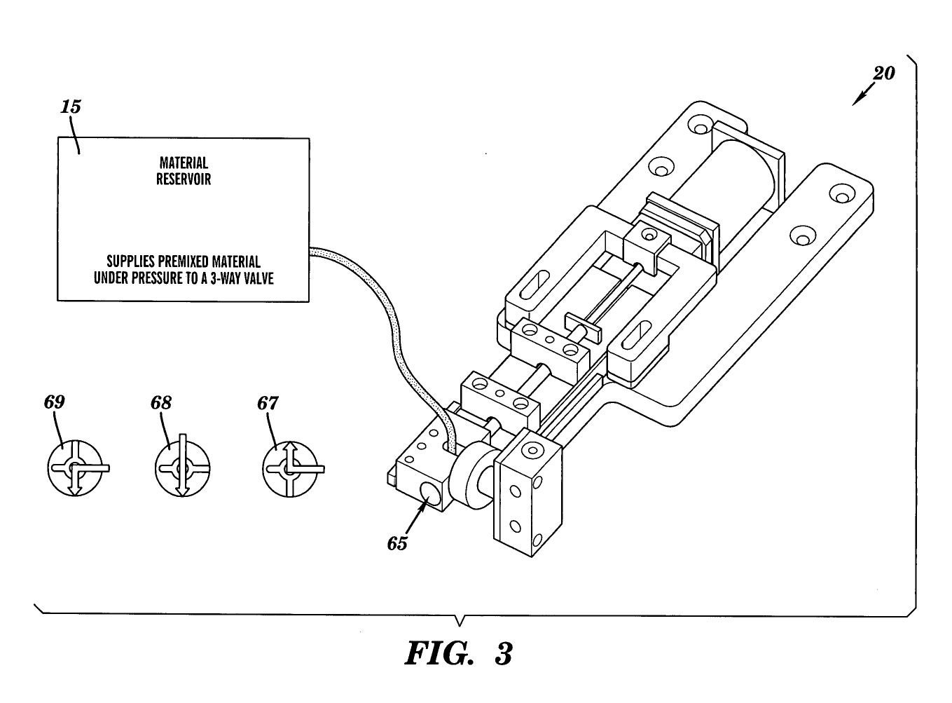

The drive mechanism 80 comprises: a motor 81, a communication interface 82, a motor mount 83, a ball screw slide 84, and the ball screw shaft 85. A first end of the motor 81 is coupled to a base plate 13 via the motor mount 83. The mount 83 may be a NEMA® (i.e., National Electrical Manufacturers Association) mount, or other suitable mechanical interface. A second end of the motor 81 is coupled to the communication interface 82. The interface 82 acts as a communication interface between the motor 81 and a control system 105 (See e.g., FIG. 3) The motor 81 may be a gear motor, servo motor, stepper motor, and the like. Beyond the mount 83 and interconnected thereto is the ball screw slide 84. On the slide 84 is the ball screw shaft 85. The motor 81 causes rotation of the ball screw shaft 85 subsequently translating, along a directional arrow 23 parallel to the screw shaft 85, the syringe yolk carriage 44 to which is engaged the terminal flat plate 26 of the syringe plunger 22.

The device 20 further comprises an material conduit 14 operationally coupled to a material inlet port 63 of the multi-directional flow valve 60. The material conduit 14 interconnects a material supply, or reservoir 15, of the material 16, shown schematically, to the flow valve 60 allowing fluid communication between the reservoir 15 and the flow valve 60.

The multi-directional flow valve 60 comprises: a stopcock aligning bracket 61, a 3-way stopcock rotary bracket 62, the material inlet port 63, a stopcock actuator 64, a 3-way stopcock 65, and a needle 66. The aligning bracket 61 operatively brings into cooperation the 3-way stopcock 65 with a syringe tip 17 and the material conduit 14 via inlet port 63. The 3-way stopcock rotary bracket 62 interconnects the 3-way stopcock 65, the stopcock actuator 64, and the needle 66, and is operatively coupled to each of the aforementioned.

The actuator 64 supplies and transmits a measured amount of force to the 3-way stopcock 65 via the 3-way stopcock rotary bracket 62. The force transmitted allows for the stopcock 65 to be set to one of three positions (See e.g., FIG. 3): a first position 67 allowing for fluid 16 flow from a material reservoir 15 to a syringe 19; a second position 68 allowing for fluid 16 flow from the syringe 19 to a workpiece 18; and a third position 69 preventing the material 16 flowing from the material reservoir 15 to the syringe 19 and from the syringe 19 to the workpiece 18.

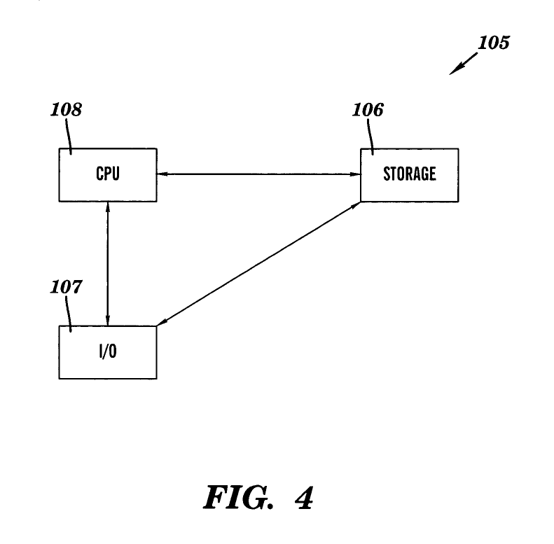

The sensors 95 are below the ball screw cover 86 and operatively in the vicinity of the ball screw slide 84. The sensors 95 are capable of precisely detecting a home/zero setting of the ball screw slide 84 and communicating the extent of the setting to the computer control system 105 (See e.g., FIG. 4).

FIG. 4 depicts a block diagram of a controller 105 for use with the dispensing device and a dispensing system in accordance with the present invention. The controller 105 comprises: a non-volatile memory, an Input/Output (I/O) device 106, and a central processing unit (CPU) 107. Although the controller 105 can take various forms, the controller 105 comprises a microprocessor based, stand-alone microcomputer. The controller 105 is programmably operable to perform simultaneous multi-axis coordinated motion with precision, accuracy, and repeatability.

A non-volatile memory 108 stores the control program and inputs, via the I/O device 106, and may comprise, for example, EEPROMs. The I/O device 106 may comprise, for example, a keyboard. The CPU 107 is at least 32-bit microprocessor. Performance characteristics include at least 8 million encoder inputs per second axis feedback, and at least 125 microsecond per axis position update rate.

Referring to FIGS. 1-4, another embodiment of the present invention is the device 20 dispensing material 16 onto a workpiece 18 such as a component 24 of a circuit board 25. To prepare the device 20 for dispensing the material 16, a user must first install a syringe 19 onto the device 20.

In order to install the syringe 19, a user can remove the syringe brackets 11 from the ball screw cover 86 via loosening of the thumbscrews 21. The syringe 19 then is placed within the receiver 75 and the syringe brackets 11 may be reinstalled. The brackets 11 secure the barrel of the syringe 19 to the ball screw cover 86 via the syringe accommodators 12. The syringe accommodators 12 may be integrally or non-integrally coupled to the brackets 12. The accommodators 12 are designed and made of materials that are form fitting to the syringe 19 being secured. Thus the brackets 12 are able to secure syringes 19 of various volumes without having to use brackets 12 solely dedicated to a syringe 19 of a particular volume.

Having secured the syringe 19 to the dispensing device 20 with the syringe brackets 11, the plunger retainer 40 then can be coupled to the syringe plunger. The top of the syringe yolk 41 is operatively adaptable to engage the terminal flat plate 26 of the syringe plunger 22. This may include a general indentation, recess, notch, and the like in the yolk 41. The recess of the yolk 41 is fitted onto the plunger 22 and secured to the yolk 41 via the yolk fastener 42. The fastener 42 is tightened to the yolk 41 using the thumbscrew 43. The yolk screw 43 secures the plunger 22 to the yolk 41 preventing the plunger 22 from becoming disengaged from the yolk 41 during use.

The multi-directional flow valve 60 then is coupled to the syringe 19. The 3-way stopcock 65 is operatively fitted onto the tip 17 of the syringe 19. This may entail snapping, screwing, non-integrally locking, and the like. Similarly, the 3-way stopcock rotary bracket 62 and the needle 66 may be fitted onto the stopcock 65. The stopcock actuator 64 then is fitted onto the rotary bracket 62. The stopcock aligning bracket 61 operatively maintains in cooperation the stopcock 65 with the syringe tip 17 and the fluid conduit 14 via the inlet port 63.

The steps of installing the syringe 19 onto the dispensing device 20, securing the syringe 19 to the plunger retainer 40, and coupling the syringe 19 to the multi-directional flow valve 60 can be performed in any order or combination thereof.

In operation of the device 20, the user enters dispensing parameters desired such as a motor 81 energization rate, a time interval for the plunger retainer 40, a volume increment of the material 16 to be dispensed, a rate of the material 16 to be dispensed, a volume flow of the material 16 from the reservoir 15 to the multi-directional flow assembly 60, the syringe 19 dimensions, a material 16 dispensing pattern, and the like into the computer control system 105. The control system 105 communicates the operational dispensing parameters to the drive mechanism 80 via the communication interface 82 and to the stopcock actuator 64 of the multi-directional flow valve 60.

The material 16 is supplied under pressure from the material reservoir 15, schematically drawn, through the material dispensing conduit 14 to the stopcock aligning bracket 61 of the multi-directional flow valve 60 via the material inlet port 63. The reservoir 15 is operatively connected to and in fluid communication with the device 20 via the fluid dispensing conduit 14. The conduit 14 may be of any length and size that allows for fluid communication between the reservoir 15 and the device 20.

The dispensing conduit 14, the inlet port 63, and the reservoir 15 are made of materials resistant to the material 16 thereby preventing curing or setting of the material 16 therein. Such materials include but are not limited to linear polyoxymethylene acetal resin, polyetherimide, fluoropolymers such as polytetrafluoroethylene (PTFE), and the like. The reservoir 15 is a physical body for containing the material 16. The reservoir 15 may be in any form that is capable of containing the material 16. For example, a reusable cartridge, a reusable bag, a reusable container, a disposable cartridge, a disposable bag, a disposable container, and the like. The reservoir 15 is designed for containing materials such as reactive and abrasive fluids. Examples of such materials 16 include but are not limited to cyanoacrylates, silicones, urethanes, filled silicones, RTVs, thermal transfer compounds, silver filled coatings, and the like.

The computer control system 105, programmably or manually, simultaneously controls the operation of the multi-directional assembly 60 and the drive mechanism 80 such as to provide operation of the aforementioned in a synchronous fashion. Thus, allowing for a controlled and a precise uptake of the material 16 from the material reservoir 15 into the syringe 19, and a controlled and a precise dispensement of the material 16 from the syringe 19 onto a workpiece 18.

FIG. 3 depicts a cross-sectional view of a 3-way stopcock 65. In accordance with the present invention, an embodiment includes further operation of the device 20 typically having three operational positions of the 3-way stopcock 65: a fill position 67 (FILL), a purge position 69 (PURGE), and a dispense position 68 (DISPENSE).

FILL 67 allows for uptake of the material 16 into the syringe 19. On command, programmably or manually, the computer control system 105 sends a signal to the stopcock actuator 64 to turn the 3-way stopcock 65 to the FILL 67 connecting to the material reservoir 15. The control system then signals, simultaneously or subsequently, the drive mechanism 80, via the communication interface 82, causing the motor 81 to be engaged. The motor 81 rotates the ball screw shaft 85 which in turn translates the syringe yolk carriage 44 upward along the directional arrow 23. The carriage 44 subsequently translates the syringe yolk 41, to which is engaged the syringe plunger 22, upward along the directional arrow 23. As the plunger 22 is retracted, the material 16 is pulled into the syringe 19 hence filling the syringe 19 with the material 16.

The volume of the material 16 taken up into the syringe 19 is regulated by the sensors 95. As the yolk 41 and subsequently the plunger 22 is retracted, the motor 81 rotates a certain number of rotations. This rotational data is communicated to the control system 105. The control system 105, through proprietary software, is able to convert the number of rotations to a distance traveled by the ball screw slide 84, to a distance displaced by the plunger 22 and into volume data. When the syringe 19 has been filled with the preset volume of material 16, the control system 105 sends a signal to the drive mechanism 80 discontinuing any more uptake of the fluid 16.

DISPENSE 68 allows for dispensing of the material 16 from the syringe 19 onto a workpiece 18. On command, programmably or manually, the computer control system 105 sends a signal to the stopcock actuator 64 to turn the 3-way stopcock 65 to the DISPENSE 69 connecting to the needle 66. The control system then signals, simultaneously or subsequently, the drive mechanism 80, via the communication interface 82, causing the motor 81 to be engaged. The motor 81 rotates the ball screw shaft 85 which in turn translates the syringe yolk carriage 44 downward along the directional arrow 23. The carriage 44 subsequently translates the syringe yolk 41, to which is engaged the syringe plunger 22, downward along the directional arrow 23. As the plunger 22 is displaced downward, the material 16 is dispensed from the syringe 19 through the needle 66 onto the workpiece 18, hence emptying or partially emptying the syringe 19 of the material 16.

The volume of material 16 dispensed out of the syringe 19 is regulated by the computer control system 105. As the yolk 41 and subsequently the plunger 22 are displaced forward, the displacement is equivalent to a predetermined number of rotations by the motor 81. The control system 105, through proprietary software, is able to convert the number of rotations to a distance traveled by the ball screw slide 84, to a distance displaced by the plunger 22 and into volume data. When the syringe 19 has been emptied of a preset volume of material 16, the control system 105 sends a signal to the drive mechanism 80 discontinuing dispensing of the material 16.

PURGE 69 allows for emptying of the material reservoir 15 of the material 16 and/or cleaning of the needle 66. On command, programmably or manually, the computer control system 105 sends a signal to the stopcock actuator 64 to turn the 3-way stopcock 65 to the PURGE 68 connecting to the material reservoir 15 and the needle 66. The material 16 may be operatively forced out the material reservoir 15 through the material conduit 14 and out the needle 18 via the 3-way stopcock 65. Alternatively, a cleaning fluid, may be operatively forced out the material reservoir 15 through the material conduit 14 and out the needle 18 via the 3-way stopcock 65.

The operations of FILL 67, DISPENSE 68, and PURGE 69 can be performed in any combination thereof for the device 20 to dispense the material 16 onto a workpiece 18.

The syringe 19 that is installed onto the dispensing device 20 may be of various volumes ranging from about 0.5 μL to about 10 ml. The volume range of the syringe 19 is not meant to limit scope of the syringes 19 that can be installed on the device 20 for dispensing material 16 in an embodiment of the present invention. Any syringe 19 that is capable of being operationally adapted to the device 20 by the syringe accommodators 12 of the syringe brackets 11 as well as the plunger retainer 40 and combinations thereof is viable for use in accordance with the device, method, and system of the present invention. The syringe 19 is made of materials resistant to the material 16 thereby preventing curing or setting of the material 16 therein. Such materials include but are not limited to linear polyoxymethylene acetal resin, polyetherimide, fluoropolymers such as polytetrafluoroethylene (PTFE), and the like.

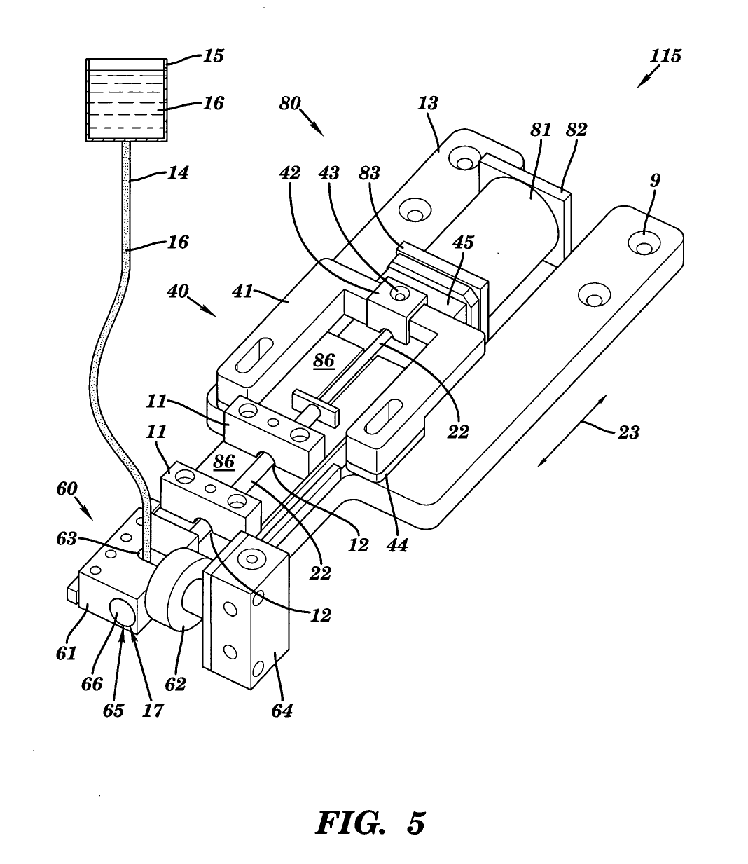

FIG. 5 depicts an embodiment of the device 20 from FIG. 1 wherein a syringe 19 has been integrally or non-integrally pre-installed on the device 20 thus transforming the device 20 into a second dispensing device 115 for dispensing material 16. Referring to FIG. 5, the device 115 comprises: a syringe 19 for dispensing the material 16; a position sensor 95; a multi-directional flow valve 60; and a syringe accommodator 12 for securing various size syringes 19 interchangeably. The syringe 19 comes pre-installed in the dispensing device 115 within the receiver 75 and secured to the device 115 via the syringe accommodators 12 of the syringe brackets 11. The syringe 19 may be removed and replaced with a syringe 19 of a different size/volume without affecting the operation of the device 115.

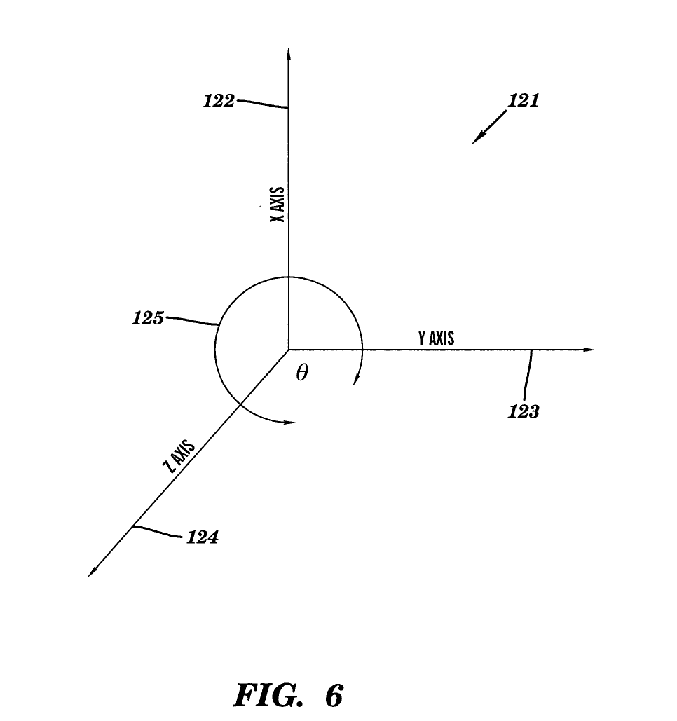

FIG. 6 depicts a Cartesian coordinate system 121 showing four axes of movement relevant to the present invention. The coordinate system 121 comprises an X axis 122, a Y axis 123, a Z axis 124, and a θ (theta) axis 125. The θ axis 125 constitutes circular motion between 0° to 360° of rotation about the Z axis 124.

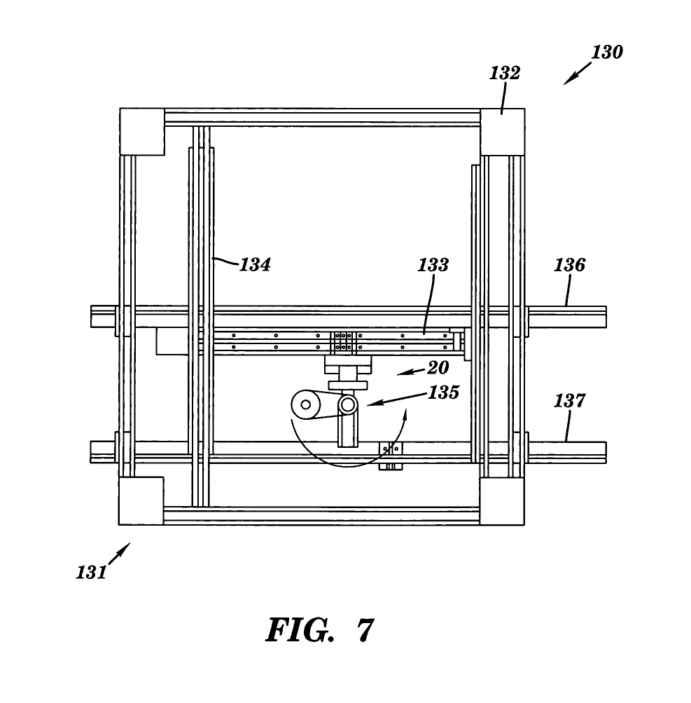

FIG. 7 depicts a top view of a dispensing system 130 for a material 16, in accordance with the present invention, comprising: a reservoir 15; a device 20 for dispensing material; a syringe 19; and a multi-degree of freedom robotic apparatus 131 operationally coupled to the device 20. The reservoir 15 is a physical body for containing the material 16. The reservoir 15 may be in any form that is capable of containing the material 16. For example, a reusable cartridge, a reusable bag, a reusable container, a disposable cartridge, a disposable bag, a disposable container, and the like. The reservoir 15 is designed for containing materials 16 such as reactive fluids, abrasive fluids, cyanoacrylate type materials, and the like.

The reservoir 15 is made of materials that prevent setting or curing of the material 16 therein. The materials are chosen from a group consisting of linear polyoxymethylene acetal resin, polyetherimide, and fluoropolymers such as polytetralfuoroethylene, and the like. The reservoir 15 is operatively connected to and in fluid communication with the device 20 via the material dispensing conduit 14. The conduit 14 may be of any length and size that allows for fluid communication between the reservoir 15 and the device 20.

The device 20, previously described, has the syringe 19 installed for operation of the device 20. The device 20 receives the material 16 from the reservoir 15 and then dispenses the material 16 via the syringe 19 onto a workpiece 18. The device 20 may be operationally coupled to an apparatus, such as a multi-degree of freedom robotic positioning apparatus 131. The base plate 13 interconnects the dispensing device 20 and the robotic apparatus 131.

The multi-degree of freedom robotic positioning apparatus 131 comprises: a frame 132, a Y axis ball screw slide 132, an X axis ball screw slide 134, an end effector 135, a first frame member 136, and a second frame member 137. The effector 135 is capable of rotation about the θ axis 125 by moving left and right along the Y axis 123 by sliding along the Y axis ball screw slide 132. Similarly, the effector 135 moves back and forth along the X axis 122 by sliding, with the frame member 136 and the frame member 137, along the X axis ball screw slide 134.

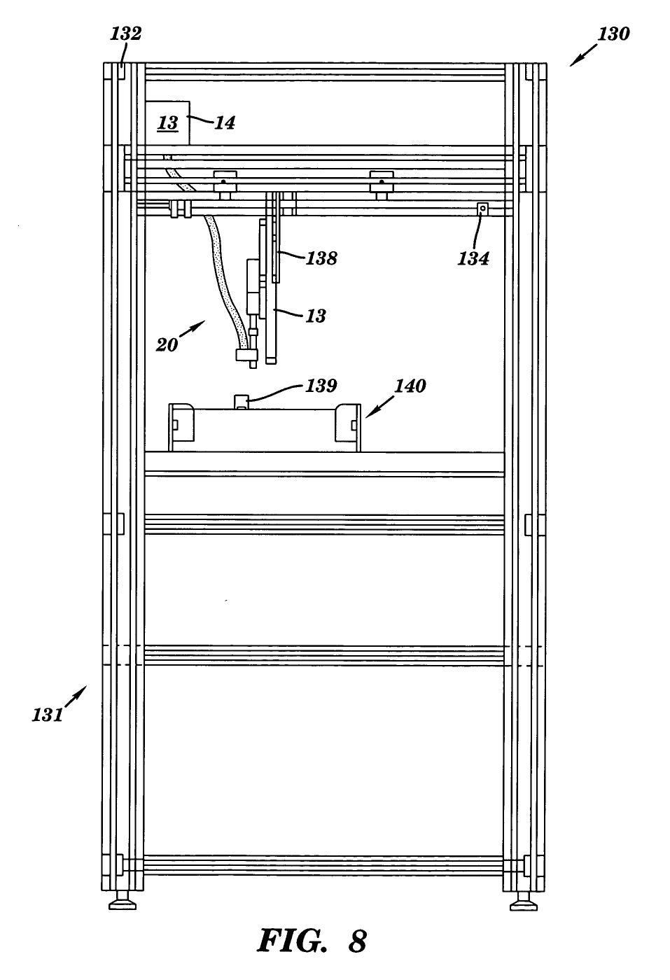

FIG. 8 depicts a side view of the dispensing system 130 of FIG. 7. The end effector 135 moves up and down on the Z axis 124 by sliding on the Z axis ball screw slide 138. The dispensing system 130 is shown in use dispensing the material 16 onto a workpiece 18. In this example, the workpiece 18 is an electrical component 139 on a circuit board 140. As shown, the dispensing device 20 is operatively attached to the Z axis screw slide 138 via the base plate 13.

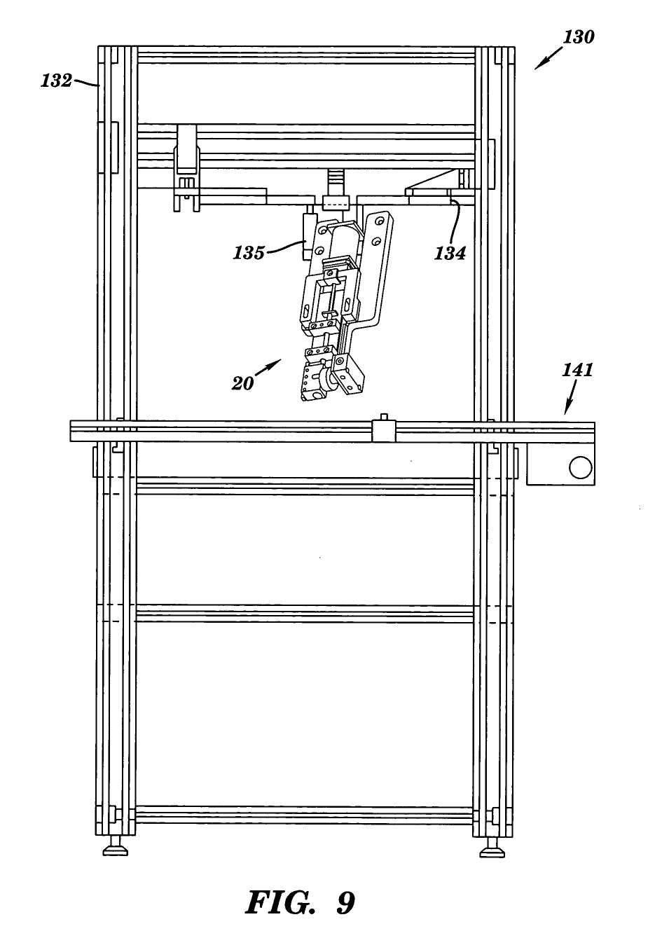

FIG. 9 depicts a front view of a dispensing system 130 of FIG. 7. As shown in FIG. 9, attached to the end effector 135 is the dispensing device 20 having an installed syringe 19. The dispensing system 130 dispenses the material 16 onto a workpiece 18. Also shown, attached to the frame 132 is a belt conveyor 141. The conveyor 141 is used to move a workpiece 18 or object through the dispensing system 130 along to another station in a production process.

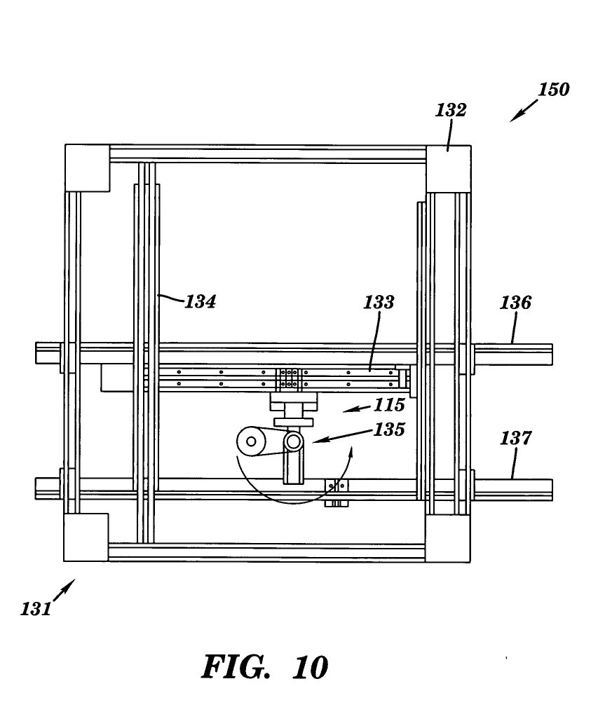

FIG. 10 depicts an embodiment of the dispensing system 130 from FIG. 7 wherein the dispensing system 130 has, operably attached, a dispensing device 115 thus transforming the dispensing system 130 into a second dispensing system 150 for dispensing materials 16. Referring to FIG. 10, the dispensing system 130 comprises: a material reservoir 15; a dispensing device 115 for dispensing the material wherein the device includes a syringe 19 and further wherein includes a syringe accommodator 12 for syringes 19 of various sizes; a multi-degree of freedom robotic apparatus 131 operationally coupled to the dispensing device 115; and a drive system, for supplying motive power to move the robotic apparatus in multi-degrees of freedom, the drive system operationally coupled to the robotic apparatus.

The syringe 19 comes pre-installed in the dispensing device 115 within the receiver 75 and secured on the device 115 via the syringe accommodators 12 of the syringe brackets 11. The syringe 19 may be removed and replaced with a syringe 19 of a different size/volume without affecting the operation of the device 115 or the system 130.

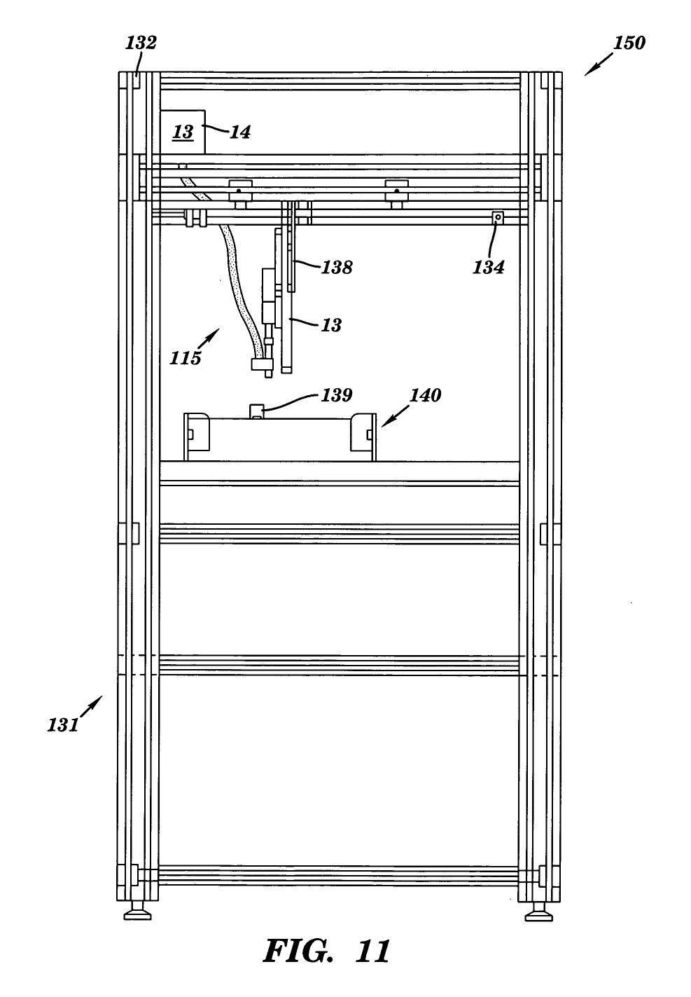

FIG. 11 depicts a side view of the dispensing system 150 of FIG. 10. The end effector 135 moves up and down on the Z axis 124 by sliding on the Z axis ball screw slide 138. The dispensing system 130 is shown in use the material 16 onto a workpiece 18. In this example, the workpiece 18 is an electrical component 139 on a circuit board 140. As shown, the dispensing device 115 is operatively attached to the Z axis screw slide 138 via the base plate 13.

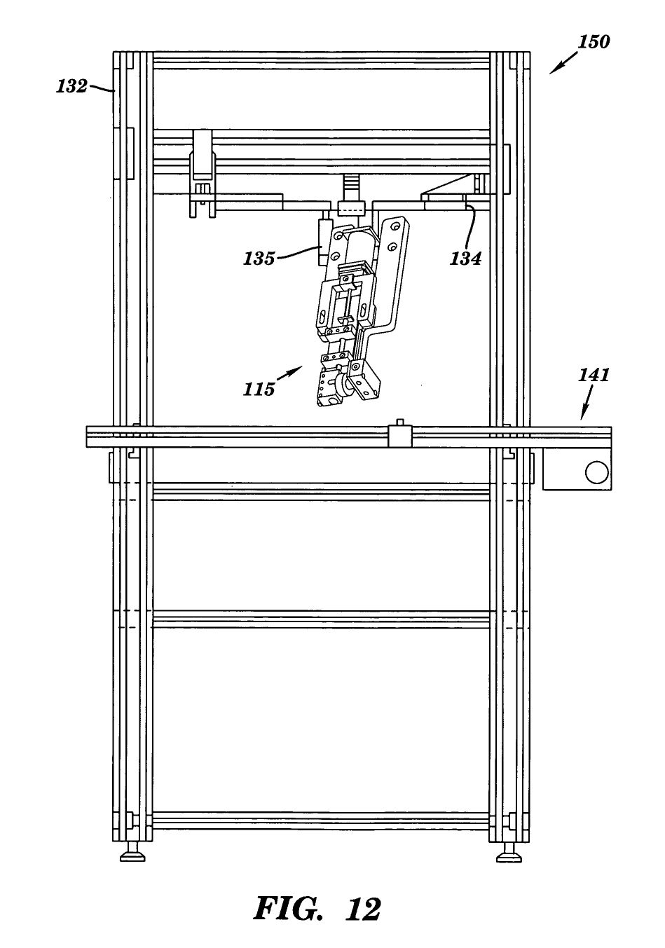

FIG. 12 depicts a front view of a dispensing system 150 of FIG. 10. As shown in FIG. 12, attached to the end effector 135 is the dispensing device 115 having an installed syringe 19. The dispensing system 130 dispenses the material 16 onto a workpiece 18. Also shown, attached to the frame 132 is a belt conveyor 141. The conveyor 141 is used to move a workpiece 18 or object through the dispensing system 130 along to another station in a production process.

Various modifications and variations of the described apparatus and methods of the invention will be apparent to those skilled in the art without departing from the scope and spirit of the invention. Although the invention has been described in connection with specific embodiments, outlined above, it should be understood that the invention should not be unduly limited to such specific embodiments. Various changes may be made without departing from the spirit and scope of the invention as defined in the following claims.

What is claimed is:

1. A device for dispensing material from a syringe, said syringe having a plunger with a terminal plate and a piston; and a syringe barrel for receiving the piston comprising:
a plunger retainer, for releasably attaching the terminal plate of said plunger;
a drive mechanism, adapted to provide motive force to said plunger head retainer;
a receiver for said syringe;
a multi-directional flow valve capable of fluid communication with a reservoir; and
a sensor for determining an amount of material dispensed from said syringe.

2. The device of claim 1, wherein said plunger retainer further comprises a syringe yolk.

3. The device of claim 1, wherein said receiver is able to accommodate syringes of variable volumes wherein the volume of said syringe is in a range from about 0.5 μL to about 10 mL.

4. The device of claim 1, further comprising syringe accommodators, said accommodator is adaptable to a syringe of variable volumes, wherein the volume of said syringe is in a range from about 0.5 μL to about 10 mL.

5. The device of claim 1, wherein said material includes a fluid selected from the group consisting a reactive fluid, an abrasive fluid, and combinations thereof.

6. The device of claim 5, wherein said reactive fluid and said abrasive fluid include a fluid selected from the group consisting of cyanoacrylate type fluid, a moisture sensitive silicone, a UV sensitive urethane, a filled silicone, a room temperature vulcanizing silicone, a thermal transfer compound, a silver filled coating, and combinations thereof.

7. The device of claim 1, wherein said material is a member of an acrylate group.

8. The device of claim 7, wherein said acrylate group consists of cyanoacrylate.

9. A method for dispensing material from a syringe, said syringe having a plunger with a terminal plate and a piston; and a syringe barrel for receiving the piston comprising:
providing a device for dispensing material, wherein said dispensing device is co-operable with a syringe;
providing said syringe, said syringe being co-operable with said dispensing device;
providing a reservoir for containing said material, wherein said reservoir is in fluid communication with said dispensing device;
operatively coupling said dispensing device to a multi-degree of freedom robotic apparatus; and
dispensing said material onto a workpiece.

10. The method of claim 9, wherein said dispensing device further comprises a plunger retainer.

11. The method of claim 9, wherein a component of said dispensing device is selected from the group consisting of linear polyoxymethylene acetal resin, polyetherimide, polytetrafluorethylene, and combinations thereof.

12. The method of claim 9, wherein said material includes a fluid selected from the group consisting a reactive fluid, an abrasive fluid, and combinations thereof.

13. The method of claim 12, wherein said reactive fluid and said abrasive fluid include a fluid selected from the group consisting of cyanoacrylate type fluid, a moisture sensitive silicone, a UV sensitive urethane, a filled silicone, a room temperature vulcanizing silicone, a thermal transfer compound, a silver filled coating, and combinations thereof.

14. The method of claim 9, wherein said material comprises an acrylate group.

15. The method of claim 9, wherein said acrylate group comprise a cyanoacrylate.

16. A system for dispensing material from a syringe, said syringe having a plunger with a terminal plate and a piston; and a syringe barrel for receiving the piston comprising:
a device for dispensing material, wherein said dispensing device is co-operable with a syringe;
a reservoir for containing said material wherein said reservoir is in fluid communication with said dispensing device;
a syringe wherein said syringe is co-operable with said device;
a multi-degree of freedom robotic apparatus operationally coupled to said device; and
a drive system, for supplying motive power to move said robotic apparatus in multi-degrees of freedom, said drive system operationally coupled to said robotic apparatus.

17. The system of claim 16, wherein a material resistant component of said dispensing device is selected from the group consisting of linear polyoxymethylene acetal resin, polyetherimide, polytetrafluoroethylene, and combinations thereof.

18. The method of claim 16, wherein said material includes a fluid selected from the group consisting of a reactive fluid, an abrasive fluid, and combinations thereof.

19. The method of claim 18, wherein said fluid includes a fluid selected from the group consisting of cyanoacrylate type fluid, a moisture sensitive silicone, a UV sensitive urethane, a filled silicone, a room temperature vulcanizing silicone, a thermal transfer compound, a silver filled coating, and combinations thereof.

20. A device dispensing material comprising:
a syringe for dispensing material, said syringe having a plunger with a terminal plate and a piston; and a syringe barrel for receiving said piston;
a sensor for determining an amount of said material dispensed from said syringe;
a multi-directional flow valve, wherein the flow valve is in fluid communication with a reservoir, wherein said reservoir is for containing said material; and
a receiver for securing various size syringes.

21. The device of claim 20, wherein said receiver is adaptable to a syringe of variable volumes wherein the volume of said syringe is in a range from about 0.5 /IL to about 10 mL.

22. The method of claim 20, wherein said material includes a fluid selected from the group consisting of a reactive fluid, an abrasive fluid, and combinations thereof.

23. The method of claim 22, wherein said fluid includes a fluid selected from the group consisting of cyanoacrylate type fluid, a moisture sensitive silicone, a UV sensitive urethane, a filled silicone, a room temperature vulcanizing silicone, a thermal transfer compound, a silver filled coating, and combinations thereof.

24. The method of claim 20, wherein said material comprises an acrylate group.

25. The method of claim 20, wherein said acrylate group comprises a cyanoacrylate.

26. A system for dispensing material comprising:
a device, wherein the device is operably coupled to a syringe, said syringe having a plunger and a piston; and a syringe barrel for receiving said piston and further wherein said dispensing device has a multi-directional flow valve;
a reservoir for containing a material wherein said reservoir is in fluid communication with said dispensing device;
a multi-degree of freedom robotic apparatus operationally coupled to said dispensing device; and
a drive system, for supplying motive power to move said robotic apparatus in multi-degrees of freedom, said drive system operationally coupled to said robotic apparatus.

27. The system of claim 26, wherein said reservoir of material includes a fluid selected from a goup consisting of a reactive fluid, an abrasive fluid, an acrylate, and combinations thereof.

28. The system of claim 26, wherein said dispensing device comprises at least one component resistant to said material.

29. The system of claim 28, wherein said material resistant component is selected from the group consisting of linear polyoxymethylene acetal resin, polyetherimide, polytetrafluoroethylene, and combinations thereof.

30. The method of claim 26, wherein said material includes a fluid selected from the group consisting of a reactive fluid, an abrasive fluid, and combinations thereof.

31. The method of claim 30, wherein said fluid includes a fluid selected from the group consisting of cyanoacrylate type fluid, a moisture sensitive silicone, a UV sensitive urethane, a filled silicone, a room temperature vulcanizing silicone, a thermal transfer compound, a silver filled coating, and combinations thereof.
